(19) United States
(12) Patent Application Publication
(10) Pub. No.: US 2012/0061213 A1
(43) Pub. Date: Mar. 15, 2012

(54) Conveyor Module, Particularly for a Band Conveyor, with Improved Pin Locking Element

(75) Inventors: Andrea MEMOLI, Grumello Del Monte (BG) (IT); Ted VAN DER HOEVEN, De Lier (NL)

(73) Assignee: SYSTEM PLAST S.r.l., Telgate (IT)

(21) Appl. No.: 13/227,048

(22) Filed: Sep. 7, 2011

(30) Foreign Application Priority Data
Sep. 10, 2010 (IT) MI2010A001645

(51) Int. Cl. B65G 17/06

(52) U.S. Cl. 198/853

(57) ABSTRACT

Module, for conveyor presenting connected modules, having upper and lower surfaces, two lateral walls, front and opposing rear walls and, projecting from front wall and rear wall module connecting elements. Connection elements each comb shaped, so one module's elements insertable between next or preceding module elements, and having through holes mutually coaxial for receiving transverse pin for removably connecting at least two modules. Each module has element blocking pin longitudinal movements including locking element removably insertable into seat in module. Seat communicates with through holes and extends from module upper to lower surface. In positions corresponding with each surface an aperture for inserting or removing locking element into or from seat. Locking element elastically deformable portion, only if deformed, enabling inserting and snap-retaining locking element in seat, preventing pin longitudinal movements. Seat end connection element, near one lateral wall, including through hole for pin passage connected to seat.

### CROSS REFERENCE TO RELATED APPLICATION

This application claims priority under 35 USC 119 from Italian Application No. MI2010A001645, filed Sep. 10, 2010, incorporated herein by reference.

### FIELD OF THE INVENTION

The present invention relates to a module for a conveyor formed by connecting together a plurality of said modules.

### BACKGROUND OF THE INVENTION

Modules of the aforedescribed type have been known for some time, however the means for locking the pin which connects one module to another are often difficult to position or remove, particularly because when the modules are employed for conveyors used in very polluted environments, for example in automobile wash stations, the dirt accumulating in the module seat which houses said locking means makes their removal difficult.

It also often happens that known locking means project at least partly from the body of the module with which they are associated, and are therefore subject to wear and damage.

### SUMMARY OF THE INVENTION

An object of the present invention is to provide a module which overcomes the above drawbacks by facilitating and simplifying the insertion/removal of the pin locking means, particularly in situations in which the modules are used in polluted environments, while safeguarding the integrity both of said locking means and of the modules.

A further object is to provide a module in which the locking means are not subject to wear.

These and other objects which will be apparent to an expert of the art are attained by a module conforming to the characterising part of the accompanying claims.

The invention provides a module for forming a conveyor, particularly a band conveyor, presenting a plurality of said modules connected together, each module comprising: an upper surface, a lower surface, two lateral walls, a front wall, an opposing rear wall and, projecting from said front wall and rear wall, a plurality of elements for connecting one module to another, said connection elements being comb shaped such that the connection elements of one module can be inserted between the elements of a next or preceding module, said connection elements each comprising a through hole, said through holes being mutually coaxial and adapted to receive a transverse pin for removably connecting at least two modules together, each module comprising means for blocking longitudinal movements of the pin, said means comprising at least one locking element removably insertable into a seat provided in the module, said seat communicating with the through hole of the connection elements for receiving the module connection pin; in which:
the seat for the locking element extends for the entire module height H, from the module upper surface to its lower surface, in positions corresponding with each of said surfaces there being an aperture for inserting/removing said locking element into or from said seat,
said locking element comprises an elastically deformable portion which, only if deformed, enables the locking element to be inserted into said seat and to remain snap-retained within said seat, so preventing longitudinal movements of the pin,
said seat is provided in an end connection element provided in proximity to one of said lateral walls,
said end element in which the seat is provided comprises a through hole for passage of the pin, said through hole being connected to the seat.

### BRIEF DESCRIPTION OF THE DRAWINGS

The invention will be better understood from the accompanying figures, which are provided by way of non-limiting example and in which:

FIG. 1 is an exploded view of a module according to the invention,

FIG. 2 is a view of the module from above,

FIG. 3 is a front view of the module,

FIG. 4 is a view from below,

FIG. 5 is an enlarged lateral view,

FIG. 6 is a lateral view in enlarged section, taken on the line 6- of FIG. 2,

FIGS. 7A, 7B, 7C show a perspective schematic view, a side view, and a top view of a locking element for the module,

FIG. 8 shows a portion of a band conveyor formed from a plurality of modules according to the invention.

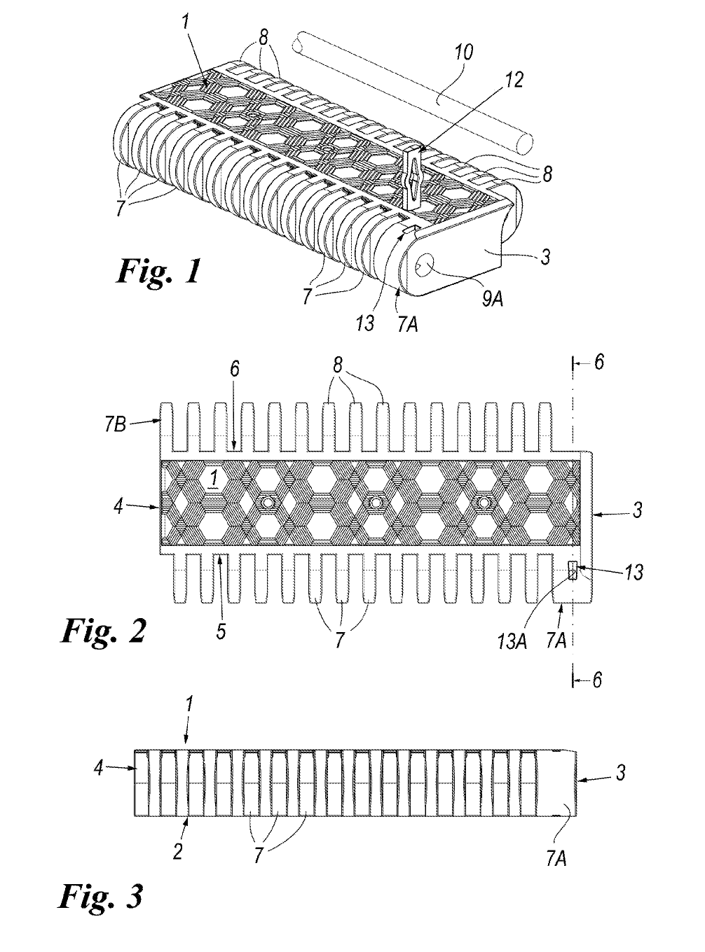

### DETAILED DESCRIPTION OF THE PREFERRED EMBODIMENTS

With reference to said figures, a module of the invention is able to form a conveyor 20 (FIG. 8), particularly a band conveyor, presenting a plurality of said modules connected together.

Each module comprises: an upper surface 1, a lower surface 2, two lateral walls 3, 4, a front wall 5, an opposing rear wall 6 (FIG. 2) and, projecting from said front wall 5 and rear wall 6, a plurality of elements 7, 8 for connecting one module to another. These connection elements 7, 8 are comb shaped such that the elements of one module can be inserted between the elements of the next or preceding module (as shown in FIG. 8). Said elements 7, 8 each comprise a through hole 9, said holes being mutually coaxial and adapted to receive a transverse pin 10 for removably connecting two or more modules together.

Each module comprises means 11 for locking the pin 10 to the module, these comprising at least one locking element 12 removably insertable into a seat 13 provided in an end connection element 7A provided in proximity to one of said lateral walls, said seat 13 communicating with the through hole 9 of the connection elements for receiving the module connection pin 10.

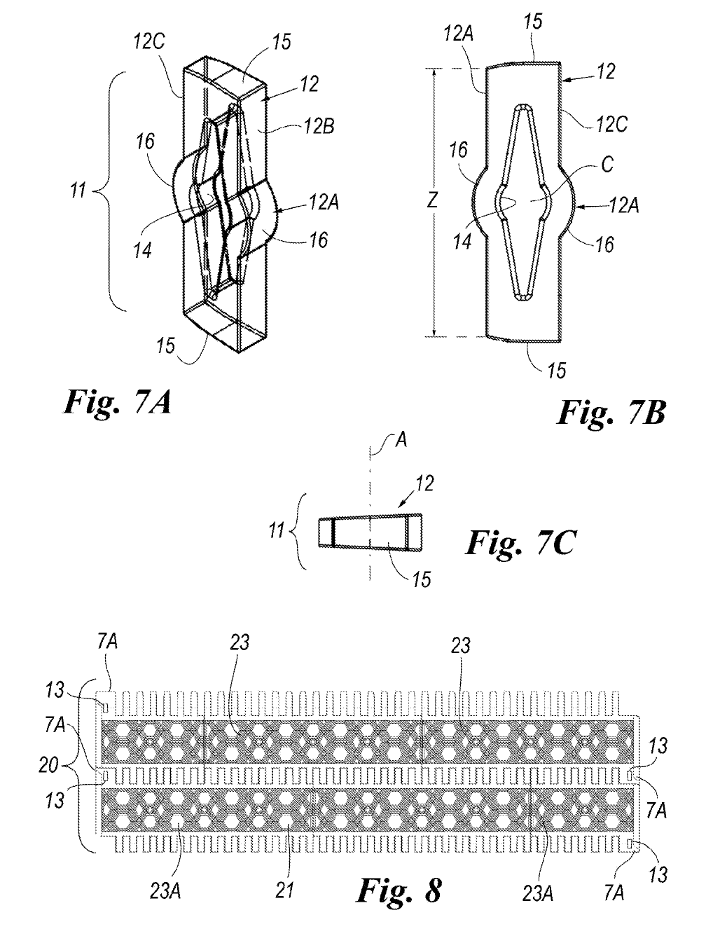

According to the invention, the seat 13 for the locking element 12 extends for the entire module height H, from the module upper surface 1 to its lower surface 2, in positions corresponding with each of said surfaces there being an aperture 13C, 13B for inserting/removing said locking element into or from said seat. Said locking element 12 comprises an elastically deformable portion 12A (FIG. 7) which, only if deformed, enables the locking element to be inserted into the seat 13 and to remain retained within said seat, so preventing longitudinal movements of the pin. The end element 7A in which the seat 13 is provided comprises a through hole 9A for passage of the pin 10, said through hole 9A being connected to the seat 13. The seat 13, the locking element 12 and the end element 7A are shaped and dimensioned such that the through hole 9A is substantially coaxial with an axis A (FIG. 7C) passing through the centre C (FIG. 7B) of a window 14 provided in a position corresponding with the deformable portion 12A of the locking element 12 when this is inserted into said seat 13. In this manner, if dirt should accumulate in the most outer part of the through hole 9A, this can be easily removed for example by a screwdriver, by inserting its tip through said hole and then through the window 14 of the locking element 12.

The locking element 12 is of substantially parallelepiped shape with its upper and lower bases 15 being trapezoidal and slightly curved, to enable the element to be inserted into the relative seat 13 only if orientated in a determined manner and to blend with the slightly curved surfaces of the end connection element 7A in which the seat is provided. The deformable portion 12A of the locking element 12 preferably comprises two semicircular parts 16 projecting centrally from the front wall 12B and rear wall 12C of the locking element at the central window 14 provided in the body of the locking element.

Advantageously the window 14 is of elongated shape and extends symmetrically to the locking element for at least one half of the element height Z, i.e. not only corresponding with the hole 9A for inserting the pin 10.

Because of the presence of the window 14 and of the fact that the locking element is formed of an at least partially elastic material (for example acetal), when said element is forcibly urged into its seat 13, which has entry openings 13C, B of dimensions substantially corresponding to those of the bases 15, the projecting deformable central portion 12A of the locking element is compressed inwards to enable the locking element to pass through said entry openings 13C. When the locking element is completely inserted into the relative seat 13, the deformable portion 12A returns elastically into its initial uncompressed position, as the seat 13 centrally comprises a widened zone 13A (FIG. 6) which houses, and has substantially the same shape and dimensions as, the projecting parts 16 of the deformable portion 12A of the locking element 12 when these are not deformed. By virtue of the particular shape of the locking element 12 and of the relative seat 13, the locking element is securely snap-locked into its seat once it has been correctly thrust into the seat. The locking element is preferably thrust into its seat for example by a hammer, and can be thrust out of its seat by a screwdriver and hammer, all without damaging either the locking element or the module, which can subsequently be reused.

The seat 13 is dimensioned and shaped complementarily to the locking element 12 when this is in its non-deformed position, so as to house it substantially flush with the upper and lower surfaces of the connection element 7A, without leaving apertures in said surfaces, and also such that the element 13 lies totally within the module.

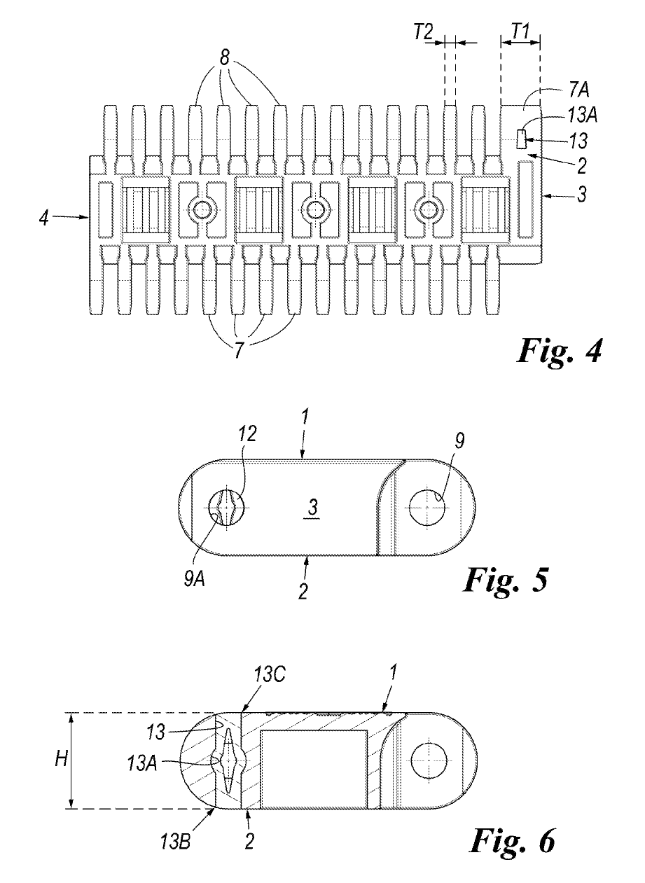

Advantageously the seat 13 for the locking element is formed entirely and only within the end connection element 7A and not also within the other module portions, for which purpose the end connection element 7A has transverse dimensions T1 (FIG. 4) greater than those of the other connection elements 7, and in particular transverse dimensions T1 at least double the transverse dimensions T2 of the other connection elements 7.

It should be noted that advantageously the locking means of the invention are entirely housed in the module interior, and are therefore not subject to wear or damage.

1. A module for forming a conveyor, presenting a plurality of said modules connected together, each module comprising:
an upper surface, a lower surface, two lateral walls, a front wall, an opposing rear wall and, projecting from said front wall and rear wall, a plurality of connection elements for connecting one module to another, said connection elements being comb shaped such that the connection elements of one module are insertable between the elements of a next or preceding module, said connection elements each comprising a through hole, said through holes being mutually coaxial and adapted to receive a transverse pin for removably connecting at least two modules together, each module comprising means for blocking longitudinal movements of the pin, these comprising at least one locking element removably insertable into a seat provided in the module, said seat communicating with the through hole of the connection elements for receiving the module connection pin; p1 the seat for the locking element extends for the entire module height, from the module upper surface to its lower surface, in positions corresponding with each of said surfaces there being an aperture for inserting/removing said locking element into or from said seat,
said locking element comprises an elastically deformable portion which, only if deformed, enables the locking element to be inserted into said seat and to remain snap-retained within said seat, so preventing longitudinal movements of the pin, when said locking element is completely inserted into said seat,
said seat is provided in an end connection element provided in proximity to one of said lateral walls,
said end element in which the seat is provided comprises a through hole for passage of the pin, said through hole being connected to the seat.

2. A module as claimed in claim 1, wherein the seat, the locking element and the end element are shaped and dimensioned such that the through hole is substantially coaxial with an axis passing through the centre of a window provided in a position corresponding with the deformable portion of the locking element when this is inserted into said seat.

3. A module as claimed in claim 1, wherein the locking element is of substantially parallelepiped shape and comprises means for correctly inserting the element into the relative seat only if orientated in a determined manner, to facilitate locking element positioning.

4. A module as claimed in claim 3, wherein the correct insertion means are such that the locking element is of substantially parallelepiped shape with its upper and lower bases being trapezoidal and slightly curved, to enable the element to be inserted into the relative seat only if orientated in a determined manner and to blend with the slightly curved surfaces of the end connection element in which the seat is provided.

5. A module as claimed in claim 1, wherein the deformable portion of the locking element comprises two parts projecting centrally from the front wall and rear wall of the locking element at a central window provided in the body of the locking element.

6. A module as claimed in claim 5, wherein the window is of elongated shape and extends symmetrically to the locking element for at least one half of the element height.

7. A module as claimed in claim 1, wherein the seat for the locking element and the locking element itself are shaped complementarily, said seat presenting entry/exit openings for said element which have dimensions substantially coinciding with those of the bases of said element, a deformable central portion projecting from said bases of said locking element being compressed inwards during insertion of said element into said seat, to enable the locking element to pass through said entry openings, when the locking element is completely inserted into the relative seat said deformable portion returning elastically into its undeformed position and seating within a widened zone of said seat, such that the locking element is securely snap-locked in its seat once the locking element has been correctly thrust into said seat.

8. A module as claimed in claim 1, wherein the seat for the locking element is formed entirely and only within one of the end connection elements and not also within the other module portions.

9. A module as claimed in claim 8, wherein the end connection element has transverse dimensions at least double the transverse dimensions of the other connection elements of the module.

10. A module as claimed in claim 1, wherein the locking element is completely housed within the seat.

11. A module as claimed in claim 1, wherein the conveyor is a band conveyor.
